(19) United States
(12) Patent Application Publication
(10) Pub. No.: US 2017/0293463 A1
(43) Pub. Date: Oct. 12, 2017

(54) SYSTEMS AND METHODS FOR MANAGING DISPLAYLESS PORTABLE ELECTRONIC DEVICES

(71) Applicant: Mighty Audio, Inc., Napa, CA (US)

(72) Inventors: Anthony Mendelson, Napa, CA (US); Mark Gullickson, Lander, WY (US); Anand Pandurangan, San Jose, CA (US)

(21) Appl. No.: 15/248,858

(22) Filed: Aug. 26, 2016

Related U.S. Application Data
(60) Provisional application No. 62/321,150, filed on Apr. 11, 2016.

(51) Int. Cl. G06F 3/16; G11B 27/00

(52) U.S. Cl. CPC G06F 3/165; G06F 3/162; G11B 27/005

(57) ABSTRACT

The present application generally relates to systems and methods for managing a displayless portable electronic device comprising at least one memory operable to store a plurality of media files, the plurality of media files being organized into a plurality of media groups; at least one wireless communication antenna operable to communicate with one or more computing devices, each of the one or more computing devices comprising a display and executing a media service application; and a processor communicatively coupled with the at least one memory and the at least one wireless communication antenna. The processor is operable to: receive a first input selected from the group consisting of: (i) a start-stop input providing access to a current media file among the plurality of media files; (ii) a back input providing access a previous media file among the plurality of media files, relative to the current media file; (iii) a forward input providing access to a next media file among the plurality of media files, relative to the current media file; and (iv) a media group selector input (e.g., playlist selector input) for scrolling through the plurality of media files; execute the first command.

### FIELD OF THE INVENTION

The present application generally relates to portable electronic devices, and more particularly to systems and methods for managing displayless portable electronic devices.

### BACKGROUND

Traditionally, digital media such as audio (e.g., songs, podcasts, audiobooks, albums, etc.) and video (e.g., movies, television shows, video podcasts), due to its copyright restrictions, has been made available for purchase on digital media sources (e.g., music stores), where a file corresponding to desired media is paid for and downloaded via a wired or wireless internet connection to the digital media sources. The downloaded media files are then transferrable to computing devices by its downloader-owner for consumption.

Streaming services now allow users (e.g., consumers) to access media on a subscription basis rather than by purchasing and downloading individual media files. That is, streaming services provide a subscription service via which users can access a large media library made available by the streaming service. The media can be consumed by “streaming” the desired media, which causes the media to be output to a user's electronic and/or computing device directly from the streaming service's systems without downloading any files corresponding to that media.

More specifically, an electronic and/or computing device accesses the streaming service's website or by downloading a corresponding streaming service application. The electronic and/or computing device connects to the streaming service via a wireless (e.g., Wi-Fi) or wired connection. Once a user has accessed (e.g., via the website or application) and is connected to the streaming service, the user browses through the library of media made available by the streaming service and selects specific media (e.g., song, video), a media group (e.g., playlist, album, folder) or the like to access (e.g., play). The media or media group is, in turn, streamed (e.g., presented, provided, persisted, output) to the user's electronic and/or computing device, where it is played, output or the like via built-in and/or connected output means such as connected headphones and built-in or connected speakers.

Because media provided by streaming services is not downloaded on a user's electronic and/or computing device, but is rather streamed from the streaming service's systems, the user's electronic and/or computing device have traditionally been required to be connected to the internet in order for the user to consume the media. Users are restricted from accessing media from the streaming service in circumstances where there is no internet or poor internet connection available, such as on airplanes, underground (e.g., subways, metro) and outside a user's signal area. Moreover, even if users have access to an internet connection, users may wish to not access media through streaming services due to the high cost of data via cellular (e.g., non-Wi-fi) connections provided by traditional wireless carriers. Thus, users' desire or opportunity to access streaming services is further limited when the user and his/her portable electronic device are located in roaming areas or simply when not connected to Wi-Fi.

Streaming services have attempted to resolve this issue by providing “offline” services, whereby a user can download media or media groups when connected to the internet, and later access that downloaded media or media groups when not connected to the internet. However, in contrast to traditional purchase and download services, this offline access provided by streaming services is still executed within the streaming service's subscription model, whereby users do not have to pay for each file or group of files downloaded. Instead, users can download media files from the streaming service, typically at no additional cost, and can delete and re-download files as desired. This therefore allows users to retain the flexibility, affordability and variety provided by streaming services while avoiding the problems caused by lack or high cost of streaming.

More specifically, offline services allow a user's electronic and/or computing device connected to the internet using a wired or wireless connection, to access media or media groups via a streaming service's website or application. The user selects media or media groups to make accessible offline and, in turn, that media or media groups are downloaded from the streaming service to the user's computing device. Typically, the downloaded files are encrypted and/or secured by the streaming service to prevent their unauthorized transmission, copying, modifying and/or the like by the user or via the user's electronic and/or computing device.

Access to offline media content by streaming services has facilitated and expanded the use of portable electronic devices. That is, because media can be made available while offline, users are more inclined to access streaming services on portable electronic devices while on-the-go, rather than merely at home, work, or at other traditional locations where internet connection is readily available. Thus, users are increasingly accessing media in more exotic, non-traditional settings, often while engaging in physical or strenuous activities where users are exposed to, for example, rapid movements, physical contact, and heightened environmental conditions (e.g., severe weather). As a result, portable electronic devices are being manufactured to lower their costs and improve their durability, to minimize the expense caused by damaging parts of the portable electronic devices. Moreover, portable electronic devices continue to trend toward smaller and lighter designs, which allow them to be more portable and desirable for on-the-go activities. One way to achieve these goals is by providing portable electronic devices that do not include a display (e.g., screen, monitor) or graphical user (GUI) interface (referred to herein as “displayless” device).

That is, by excluding displays from portable electronic devices, the devices are less expensive to manufacture, more durable, smaller and lighter (e.g., more portable). On the other hand, the absence of displays from portable electronic devices eliminates users' ability to view displayed information (e.g., media or media group details) and interact with the portable electronic device, thereby limiting or eliminating users' ability to identify, target and/or select specific media or media groups based on corresponding identifying data.

There is a need therefore for systems and methods for managing displayless portable electronic devices. There is also a need for said systems and methods to allow users to identify and select media to access on the displayless portable electronic device.

### SUMMARY

The example embodiments presented herein are directed to systems and methods for managing displayless portable electronic devices.

In some example embodiments, a system is provided for managing a displayless portable electronic device comprising: at least one memory operable to store a plurality of media files (e.g., audio files, audio component of video files, audio transcription of text file), the plurality of media files being organized into a plurality of media groups (e.g., playlist, album, folder); at least one wireless communication antenna (e.g., Bluetooth, WiFi) operable to communicate with one or more computing devices, each of the one or more computing devices comprising a display and executing a media service application; and a processor communicatively coupled with the at least one memory and the at least one wireless communication antenna, the processor being operable to: receive a first input (e.g., push, tap, click, press) selected from the group consisting of: (i) a start-stop input (e.g., play-pause input) providing access to a current media file among the plurality of media files; (ii) a back input providing access a previous media file among the plurality of media files, relative to the current media file; (iii) a forward input providing access to a next media file among the plurality of media files, relative to the current media file; and (iv) a media group selector input (e.g., playlist selector input) for scrolling (e.g., traversing (e.g., in a liner order, in a shuffled order)) through the plurality of media files; execute the first command.

In some example embodiments, the start-stop input is a play-pause input, and the media group selector input is a playlist selector input.

In some example embodiments, the first input is received via a corresponding button selected from the group consisting of: a start-stop button corresponding to the start-stop input, a back button corresponding to the back input, a forward button corresponding to the forward input, and a media group selector button corresponding to the media group selector input.

In some example embodiments, the first input is the playlist selector input (e.g., via a media group selector button). Responsive to the receiving of the first input (e.g., from a user), and to execute the first input, the processor is operable to: for each media group among the plurality of media groups, output (e.g., voice over, audio output) a dictation of a respective media group identifier (e.g., media group name, title, label, tags, date).

In some example embodiments, the processor is operable to receive a second input within a predetermined time (e.g., 1 second, 2 seconds, 3, seconds, 4 seconds, 5 seconds) measured from the output of the dictation of the respective media group identifier.

In some example embodiments, the processor is operable to receive a second input prior to the output of the dictation of a next respective media group identifier.

In some example embodiments, the dictation of each respective media file group identifier corresponding to the plurality of media file groups is performed in a predetermined order (e.g., alphabetically by title, name or other identifier; chronologically by date added, date created, date modified).

In some example embodiments, the media files are audio files and the media groups are playlists.

In some example embodiments, the at least one wireless communication antenna is selected from the group consisting of Bluetooth and Wi-Fi.

In some example embodiments, the at least one memory is operable to store a media service application (e.g., streaming service application, music streaming service application).

In some example embodiments, the receiving of the second input, causes a media group corresponding to the last dictated media group identifier to be accessed (e.g., played).

In some example embodiments, the processor is further operable to: establish a virtual network computing (VNC) connection with a first computing device (e.g., mobile device); and receive, using the VNC connection, one or more media files or media groups selected at the computing device for offline access (e.g., access without internet or Wi-Fi connection).

In some example embodiments, the plurality of media files and/or the media service application stored and/or executing on the portable electronic device are managed (e.g., edited, deleted, controlled) via inputs received at the first computing device connected over the VNC connection.

In some example embodiments, the inputs received at the first computing device connected over the VNC connection are received via peripheral devices (e.g., mouse, keyboard) connected to the first computing device.

In some example embodiments, a method is provided for managing a displayless portable electronic device comprising: storing, in at least one memory, a plurality of media files (e.g., audio files, audio component of video files, audio transcription of text file), the plurality of media files being organized into a plurality of media groups (e.g., playlist, album, folder); providing communications via at least one wireless communication antenna (e.g., Bluetooth, WiFi) operable to communicate with one or more computing devices, each of the one or more computing devices comprising a display and executing a media service application; receiving, by the processor, a first input (e.g., push, tap, click, press) selected from the group consisting of: (i) a start-stop input (e.g., play-pause input) providing access to a current media file among the plurality of media files; (ii) a back input providing access a previous media file among the plurality of media files, relative to the current media file; (iii) a forward input providing access to a next media file among the plurality of media files, relative to the current media file; and (iv) a media group selector input (e.g., playlist selector input) for scrolling (e.g., traversing (e.g., in a liner order, in a shuffled order)) through the plurality of media files; and executing, by the processor, the first command.

In some example embodiments, the start-stop input is a play-pause input, and the media group selector input is a playlist selector input.

In some example embodiments, the first input is received via a corresponding button selected from the group consisting of: a start-stop button corresponding to the start-stop input, a back button corresponding to the back input, a forward button corresponding to the forward input, and a media group selector button corresponding to the media group selector input.

In some example embodiments, the first input is the playlist selector input (e.g., via a media group selector button), and, responsive to the receiving of the first input (e.g., from a user), and to execute the first input, the method further comprises: for each media group among the plurality of media groups, outputting (e.g., voice over, audio output) a dictation of a respective media group identifier (e.g., media group name, title, label, tags, date).

In some example embodiments, the method further comprises: receiving, by the processor, a second input within a predetermined time (e.g., 1 second, 2 seconds, 3, seconds, 4 seconds, 5 seconds) measured from the output of the dictation of the respective media group identifier.

In some example embodiments, the method further comprises receiving, by the processor, a second input prior to the output of the dictation of a next respective media group identifier.

In some example embodiments, the dictation of each respective media file group identifier corresponding to the plurality of media file groups is performed in a predetermined order (e.g., alphabetically by title, name or other identifier; chronologically by date added, date created, date modified).

In some example embodiments, the media files are audio files and the media groups are playlists.

In some example embodiments, the at least one wireless communication antenna is selected from the group consisting of Bluetooth and Wi-Fi.

In some example embodiments, the method further comprises storing a media service application (e.g., streaming service application, music streaming service application) in the at least one memory.

In some example embodiments, the receiving of the second input, causes a media group corresponding to the last dictated media group identifier to be accessed (e.g., played).

In some example embodiments, the method further comprises establishing, by a processor, a virtual network computing (VNC) connection with a first computing device (e.g., mobile device); and nreceiving, by a processor, using the VNC connection, one or more media files or media groups selected at the computing device for offline access (e.g., access without internet or Wi-Fi connection).

In some example embodiments, the plurality of media files and/or the media service application stored and/or executing on the portable electronic device are managed (e.g., edited, deleted, controlled) via inputs received at the first computing device connected over the VNC connection.

In some example embodiments, the inputs received at the first computing device connected over the VNC connection are received via peripheral devices (e.g., mouse, keyboard) connected to the first computing device.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a diagram of a system for managing displayless portable electronic devices, according to an exemplary embodiment.

FIG. 2 is a sequence diagram illustrating a process of syncing media to a portable electronic device, according to an exemplary embodiment.

FIG. 3 is a flow chart illustrating a process of accessing media and media groups on a portable electronic device, according to an exemplary embodiment.

FIG. 4 is a block diagram of an example network environment for use in the methods and systems described herein, according to an illustrative embodiment.

FIG. 5 is a block diagram of an example computing device and an example mobile computing device, for use in illustrative embodiments of the invention.

### DETAILED DESCRIPTION

The example embodiments described herein are directed to systems and methods for managing displayless portable electronic devices, according to an exemplary embodiment.

### System:

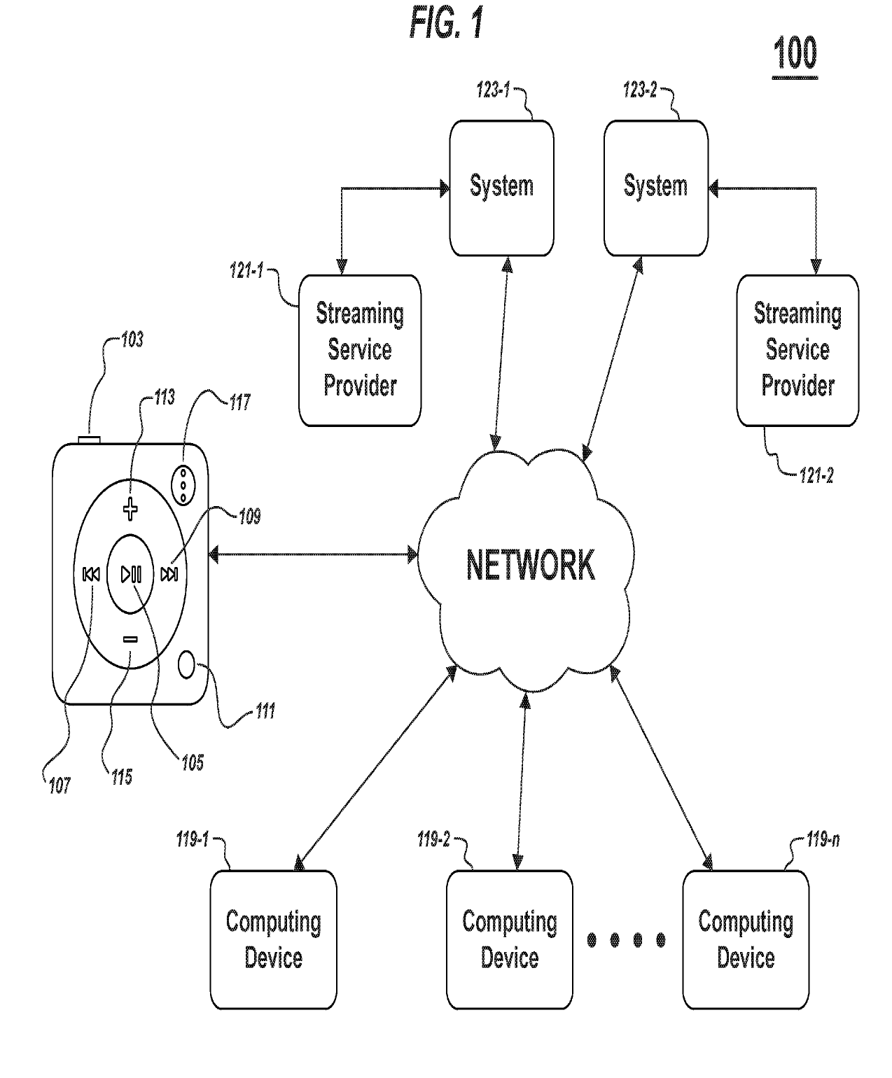

FIG. 1 is a diagram of a system 100 for managing displayless portable electronic devices, according to an exemplary embodiment. As can be seen in FIG. 1, system 100 includes a portable electronic device 101. The portable electronic device 101 includes buttons via which inputs can be received to transmit instructions, commands, prompts and/or the like. The portable electronic device 101 is displayless, meaning that it does not include a screen, interface or the like via which to receive inputs and/or output information. Thus, a user communicates (e.g., inputs commands) with the portable electronic device 101 via its buttons or inputs. In some example embodiments, the portable electronic device receives audio inputs from a user, such that instructions and/or commands can be input by voice or audio via a microphone or similar input device connected to the portable electronic device 101. A user receives information from the displayless portable electronic device 101 using audio, which is provided to a user via an audio output provided by or connected to the portable electronic device (e.g., connected headphones, connected speakers, built-in speakers, and the like).

In some example embodiments, the buttons on the portable electronic device 101 include a power button 103, a play-pause button 105, a back button 107, a forward button 109, a shuffle button 111, a volume up button 113, a volume down button 115, and a playlist selector button 117. These buttons are described in further detail below in connection with FIG. 1. It should be understood that the buttons may also be referred to as inputs, and can be shaped in and/or organized a variety of ways. It should be understood that each of the buttons 103-117 are mapped to corresponding actions on the streaming service application stored on the portable electronic device 101, such that the buttons allow an application to be controlled using the physical buttons of the portable electronic device 101 rather than via inputs displayed on a display.

Although not illustrated in FIG. 1, the portable electronic device 101 also includes one or more antennas, one or more memories and a processor, all of which are communicatively coupled. In some example embodiments, the antennas provide wireless communication capabilities and/or wireless signal transmission with other computing or electronic devices, via Bluetooth, Wi-Fi or the like. For instance, the antennas may be used to transmit and receive media files by the portable electronic device 101. In some example embodiments, the portable electronic device 101 includes a port in which to connect a wire, cable or the like to establish a wired connection (e.g., USB, micro-USB type B, USB-C) with another device (e.g., computing device). It should be understood that, in some example embodiments, the portable electronic device 101 does not have cellular, 3G, 4G, LTE or a similar connection, in contrast to other computing or electronic devices (e.g., mobile device, laptop, tablet).

The one or more memories of the portable electronic device 101 are used to store, among other things, applications, software and/or media files. In some example embodiments, the one or more memories of the portable electronic device 101 store a streaming service application such as a music streaming service application (hereinafter “music streaming service application”) provided by a streaming service provider. The music streaming service application may be pre-provisioned on the portable electronic device 101 such that it is available for use upon purchase, without the need to download a streaming application. That is, in some instances, the music streaming service application is pre-provisioned, installed, provisioned or the like by the portable electronic device manufacturer. The music streaming service application provides access to media without having to purchase or download the media files (e.g., audio files) corresponding to the desired media. Instead, the media is presented, upon request, to an end-user at the end-user's computing device.

In some example embodiments, music streaming service applications provide “offline” capabilities, whereby media files are downloaded to the portable electronic device 101, with restrictions. That is, media files are downloaded and stored and/or encrypted in a way where their access and/or ability to be copied, edited, modified, transmitted and the like are limited.

The portable electronic device 101 stores media files such as audio files, video files and the like. The audio files may correspond to songs, podcasts and the like, which are stored in a file format type such as MP3, WAV, OGG, Vorbis, FLAC, AAC. In some example embodiments, the media files are stored in and/or associated with one or more media groups. The media groups may be playlists, albums, or any other grouping of media files.

Still with reference to FIG. 1, the buttons of the portable electronic device 101 are used to manage and/or control access to the media files stored in the memory of the portable electronic device 101. The power button 103 toggles the portable electronic device 101 and its functionalities (e.g., power, antenna signal transmission capabilities) from an ON state to an OFF state. The play-pause button 105 provides and restricts access to a media file. For example, the play-pause button 105 provides access to an audio file by playing the file, and also suspends the access to that audio file by pausing the file. The back and forward buttons 107 and 109, respectively switch from a currently accessed file to the previously accessed file and the next file to accessed, respectively.

It should be understood that media files are accessed, played and/or transitioned through within a respective media group. In some example embodiments, when a song (e.g., media file, audio file) is played, it is played within the context of its corresponding playlist or media group. Thus, when another song is to be played (e.g., because the current song has ended; responsive to pressing the forward or next button), the next song within the currently active playlist is played. In other words, accessing and toggling back and forth between media files occurs within a currently active or selected media file group.

The order of accessing the files within a media group (e.g., playlist) may be predetermined, for example, based on an order in which the files were saved, a preselected order, an order based on selected criteria (e.g., alphabetical, chronological, etc.). The order of accessing the files and/or transitioning between one media file to the next may be shuffled or randomized by selecting the shuffle button 111 on the portable electronic device 101. More specifically, when the shuffle button 111 is selected, the order of accessing the files may be modified from a default, original or preselected order to a randomized order. The volume up button 113 and volume down button 115 of the portable electronic device are used to increase and/or decrease the volume of the media file.

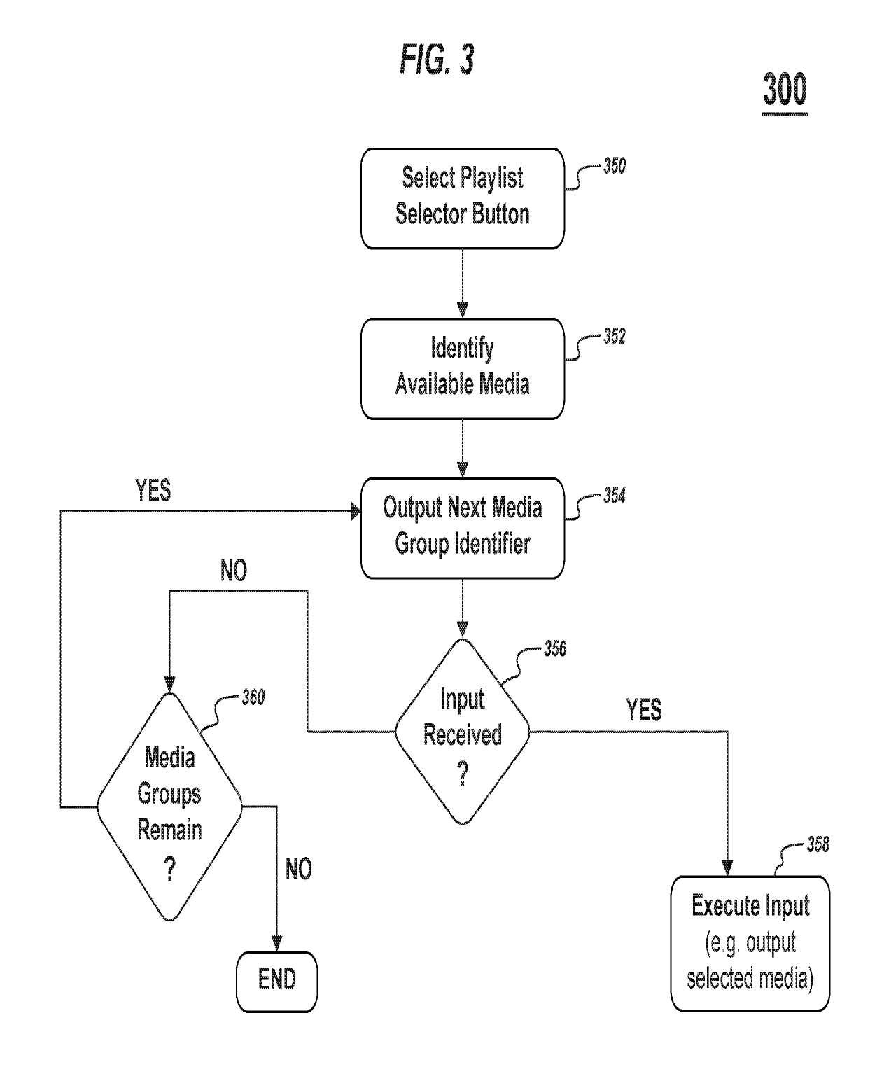

As described in further detail above, the playlist selector button 117 allows a user to identify a media group (e.g., playlist, album, etc.) to access (e.g. play). That is, when the playlist selector button 117 is pressed, selected, touched or the like, the portable electronic device 101 outputs audio associated with each of the media groups stored on the portable electronic device, thereby allowing a user to identify a playlist to be selected without access to a display on the portable electronic device 101. Operation of the playlist selector button 117 is described below in further detail with reference to FIG. 3.

Still with reference to FIG. 1, the system 100 includes computing devices 119-1, 119-2, . . . , 119-n (collectively “computing devices,” “119,” and “computing devices 119”). The computing devices 119 may be wearable devices, laptops, desktops, tablets, wearable devices, and the like, with which the portable electronic device 101 communicates. Although not illustrated in FIG. 1, the computing devices 119 each include a processor and at least one memory. In addition, although not shown in FIG. 1, each of the computing devices 119 may include and/or be connected to a display, screen, monitor, or the like. In some example embodiments, the computing devices 119 are managed, controlled and/or accessed by a user associated with the portable electronic device 101. The portable electronic device 101 communicates with the computing devices 119 via wired or wireless connections (e.g., Bluetooth, Wi-Fi or the like.)

Each of the computing devices 119 has stored and/or executes thereon a streaming service application (e.g., music streaming service) corresponding to a streaming service application stored on the portable electronic device 101. In some example embodiments, the streaming service application authenticates a user using login information (e.g., username and password) and, in turn, provides access to a streaming service account. A streaming service may store a user's streaming service account information, such as a user profile, settings, media preferences (e.g., favorites, history, starred, etc.) and the like. The user's streaming service account information is stored locally, at a computing device 119 associated with (e.g., logged into) by the user, and/or remotely, at the streaming service provider's systems and/or servers. The service account information, in some example embodiments, is available to and/or replicated to each of the computing devices 119 with which the user is associated, to be locally accessed thereat.

A user operating a computing device 119 may access (e.g., play) media, create playlists, select favorite albums, playlists and songs, and use many other streaming service functionalities typically offered by streaming service providers and their applications. In some example embodiments, a user selects media or media groups for offline access, either at the computing device 119 being used, or at another computing device or portable electronic device associated with the user. If a user selects media for offline access at the computing device 119 being operated, the selected media is downloaded onto the memory of that computing device 119 either substantially simultaneously with that request or at another time, as indicated by predetermined settings (e.g., upon connecting to a Wi-Fi connection). On the other hand, a user may operate a computing device 119 as a remote client being used to access (e.g., operate, communicate on behalf of) the portable electronic device 101, for example, to select media for offline access at the portable electronic device 101.

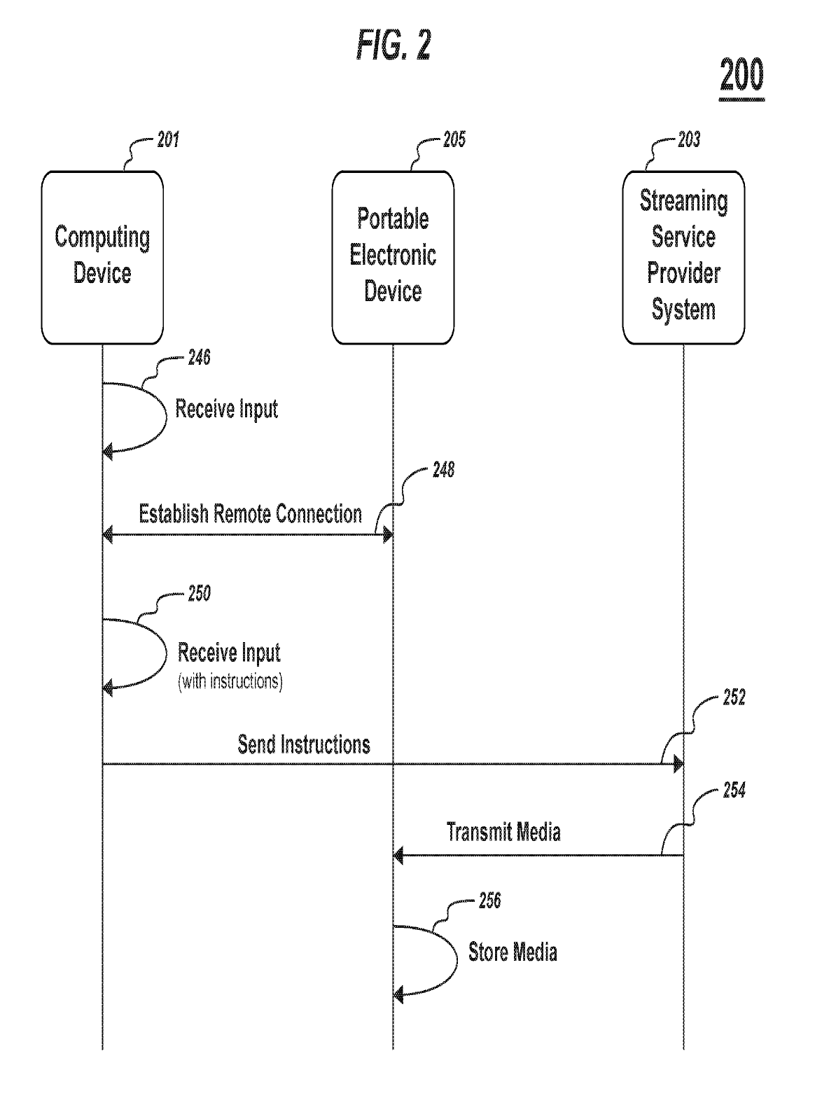

In some example embodiments, a computing device 119-1 is used as a client system in a remote client-server architecture (e.g., virtual network computing (VNC) architecture) to operate the portable electronic device 101, which is used as the remote system or server being accessed. In such cases, the computing device 119-1 executes an instance of an application stored at and corresponding to the portable electronic device 101. The computing device 119-1 is operated to control the portable electronic device 101 and, more specifically, to select media for offline access at the portable electronic device 101. In turn, the selected media is downloaded onto a memory of or associated with the portable electronic device 101 using a wired or wireless connection. Depending on predetermined and/or default settings, the media may be pushed by the media source (e.g., streaming service provider) to the portable electronic device 101, or it may be pulled from the media source to the portable electronic device 101 when requested by the portable electronic device (e.g., upon pressing a button, selecting an input on the portable electronic device 101). This process of syncing a portable electronic device is described in further detail below with reference to FIG. 2.

Still with reference to FIG. 1, as described above, computing devices 119 are associated with one or more streaming service provider systems managed by corresponding streaming service providers. In one example embodiment, each of the computing devices 119 is associated with streaming service providers 121-1 and 121-2 (collectively “streaming service providers,” “121,” or “streaming service providers 121”) that are associated with and/or manage, respectively, streaming service provider systems 123-1 and 123-2 (collectively “streaming service provider systems,” “123,” or “streaming service provider systems 123”).

The streaming service provider systems 123 are accessed by the corresponding computing devices 119 or portable electronic device 101, for example, via respective streaming service provider applications. In turn, the computing devices 119 and/or the portable electronic device 101 (e.g., being controlled remotely by a computing device) may access streaming service providers' services, as described above, including browsing media and media groups, playing media, creating and playing media groups (e.g., playlists, albums), selecting favorites, and identifying media and/or media groups for offline access. In some example embodiments, when media and/or media groups are selected for offline access, they are downloaded and/or synced to desired computing devices (e.g., 119) and/or portable electronic devices (e.g., 101), via a wired or wireless connections. It should be understood that each of the service providers 121 may provide different functionality, applications, interfaces, inputs, files types, encryption techniques, and the like.

### Syncing Media to Portable Electronic Device

FIG. 2 is a sequence diagram 200 illustrating a process of syncing media to a portable electronic device, according to an exemplary embodiment. More specifically, FIG. 2 illustrates syncing media to a portable electronic device 205 (e.g., FIG. 1, portable electronic device 101). As shown in FIG. 2, a computing device 201 (e.g., FIG. 1, computing device 119-1) and streaming service provider system 203 (e.g., FIG. 1, streaming service provider system 123-1) may participate in the syncing of the portable electronic device 205. The portable electronic device 205, streaming service provider system 203 and/or computing device 201 are communicatively coupled via wired or wireless connections (e.g., over one or more networks).

At step 246, the computing device 201 receives an input (e.g., from a user) to access (e.g., run, execute) an instance of a streaming service application stored on and corresponding to the portable electronic device 205. In turn, at step 248, the computing device 201 establishes a remote connection with the portable electronic device 205, for example, using a wired or wireless (e.g., Wi-Fi- Bluetooth) connection. The remote connection may be a virtual network computing (VNC) connection and/or architecture, in which one system (e.g., computing device 201) acts as a client that is able to remotely access and/or operate another system (e.g., portable electronic device 205) acting as a server. Although illustrated as a single step in FIG. 2, it should be understood that establishing a remote connection between the computing device 201 and the portable electronic device 205 may comprise one or more communications such as: sending an IP address and port information from the client to the server; determining the validity of the client (e.g., verifying the client's IP address and port information); and establishing a connection.

At step 250, the computing device 201 (e.g., display-equipped mobile device) receives an input (e.g., from a user) via a streaming service application stored on the portable electronic device 205 and executing and/or being accessed on the computing device 201. The streaming service application is an instance of a streaming service application corresponding to the portable electronic device 205 and which is accessible by the computing device 201 via the remote (e.g., VNC) connection. The input received by the streaming service application may be and/or include instructions to provide offline access to selected media groups (e.g., playlists) on the portable electronic device 205. It should be understood that the media selected for offline access may be individual media, media groups, and the like. In some example embodiments, the media groups for offline access may be selected via the display of the computing device 201 using the streaming service application.

In turn, at step 252, computing device 201 transmits the input instructions to the streaming service provider system 203, including information identifying the media groups selected for offline access. In some example embodiments, the streaming service provider 203 verifies and/or validates the requesting system and/or instructions. At step 254, the streaming service provider system 203 transmits the selected media groups to the portable electronic device 205 (e.g., by pull or push methods). The selected media groups, subsequent to their receipt at the portable electronic device, may be stored in permanent or temporary memory of the computing, at step 256.

As discussed above, in some example embodiments, the computing device 201 and the portable electronic device 205, which are connected via a wired or wireless connection, interact and/or communicate using a VNC connection and/or architecture. That is, the computing device 201 and the portable electronic device 205 are equipped with respective client/server functionality that allows the computing device 201 to act as a viewer or client and the portable electronic device 205 to act as a server component. The VNC architecture thus allows the computing device 201 to control the portable electronic device 205 via the computing device 205's keyboard, mouse, display and/or other peripheral device. For instance, a user may use the display of the computing device 201 as if it were the display of the portable electronic device 205 (which is a displayless device), such that a user can (1) view media or media groups, applications and other data stored in the memory of the portable electronic device 205; and (2) organize, modify, or delete media or media groups, application and other data stored in the memory of the portable electronic device.

Media and media groups, once synced to and stored on the portable electronic device 205, can be accessed (e.g., played) and output via a wired or wireless connected device (e.g., headphones, speakers).

### Media and Media Group Access

FIG. 3 is a flow chart 300 illustrating a process of accessing media and media groups on a portable electronic device, according to an exemplary embodiment. More specifically, FIG. 3 illustrates the use of a playlist selector button to operate a portable electronic device and select media and/or media groups to access. As described above in further detail with reference to FIG. 1, a portable electronic device may include a playlist selector button (e.g., media selector button) or similar input.

At step 350, a user selects (e.g., clicks, taps, presses) a playlist selector button on the portable electronic device equipped with (e.g., having stored thereon) media separated and/or grouped into media groups. In turn, selecting the playlist selector button causes the portable electronic device, at step 352, to identify and/or determine the media groups stored on and/or available for access (e.g., playing), as well as an order of desired traversal at that particular time. For instance, the order of traversing (e.g., scrolling) through the media groups may be selected by default (e.g., preset) or chosen by a user of the portable electronic device. In some example embodiments, the order for traversing the media groups may be alphabetical (e.g., by various identifiers associated with the media group (e.g., group name, title, description)), chronological (e.g., based on time when group was added, modified, created), or by other criteria such as frequency of access (e.g., favorites, starred).

At step 354, the portable electronic device outputs (e.g., plays, dictates) an audio identifier (e.g., name, title) associated with the next media group, starting with the first media group on the first output after the playlist selector button is pressed. In turn, the system pauses for a predetermined amount of time (e.g., 1 second, 2 seconds, 3, seconds, 5 seconds, 10 seconds), and determines, at step 356, whether an input has been received during that predetermined amount of time. In some example embodiments, the input is a press, push, selection or the like of the playlist selector button, play button or another button indicating a user's desire to access the media group associated with the last output (e.g., dictated) audio identifier. That is, a user input (e.g., of a playlist selector or play button) generates instructions or a command for the processor of the portable electronic device to take corresponding action.

In some example embodiments, output of the audio identifier of each media group is performed using text-to-speech software or functionality stored and/or executing on the portable electronic device.

If it is determined at step 356 that an input was received (e.g., of the playlist selector button, play button, or the like), the portable electronic device accesses and/or outputs the media group associated with the last output audio identifier, at step 358. The media group may be output via internal (e.g., built-in) audio output device, or an output device connected thereto. The media within the media group is output in various orders, including alphabetically, chronologically, or by other criteria.

On the other hand, if it is determined at 356 that an input was not received during the pause for the predetermined time, the portable electronic device determines, at step 360) whether audio identifiers for any media groups stored thereon have not been dictated since the playlist selector button was pressed (e.g., media groups remain to be traversed). If so, the portable electronic device returns to step 354, where an audio identifier (e.g., name, title) associated with the next media group is output. The portable electronic device iterates through this process (e.g., steps 354, 356, 360) until the playlist selector button is pressed a second time, the play button is selected, or all of the media groups have been traversed through. That is, if it is determined at step 358 that audio identifiers for media groups stored on the portable electronic device are not remaining to be output, the process ends (e.g., the portable electronic device continues its previous action, goes into a sleep mode or the like, or shuts down).

In one example embodiment, a portable electronic device includes headphones connected thereto via a headphone jack. The portable electronic device has stored thereon five playlists titled: “workout,” “nighttime,” “study,” “roadtrip,” and “weekend.” Each of the playlists is made up of multiple songs. A user operating the portable electronic device presses the playlist selection button on the portable electronic device. In turn the portable electronic device identifies the five playlists stored on (e.g., available offline) the portable electronic device. The portable electronic device dictates and/or outputs, in audio form, the title of a first playlist (e.g., “workout”) via the headphones connected thereto. The portable electronic device does not take any action for e.g., 2 seconds and awaits a user input. When no input is received after two seconds have passed, the portable electronic device identifies the next playlist stored on the device (e.g., “nighttime”) and outputs the title of that playlist via the headphones connected thereto. During the subsequent pause, a user presses a button (e.g., play, playlist selector button) indicating a desire to access the “nighttime” playlist. In turn, the portable electronic device recognizes the user input and (1) stops the process of traversing through the playlist, and (2) retrieves and plays the songs making up the “nighttime” playlist.

The playlist selector button therefore allows a user to select a playlist to listen to, from among multiple playlists stored on a portable electronic device, even when the portable electronic device does not have a display (e.g., screen) with which to interact or view information.

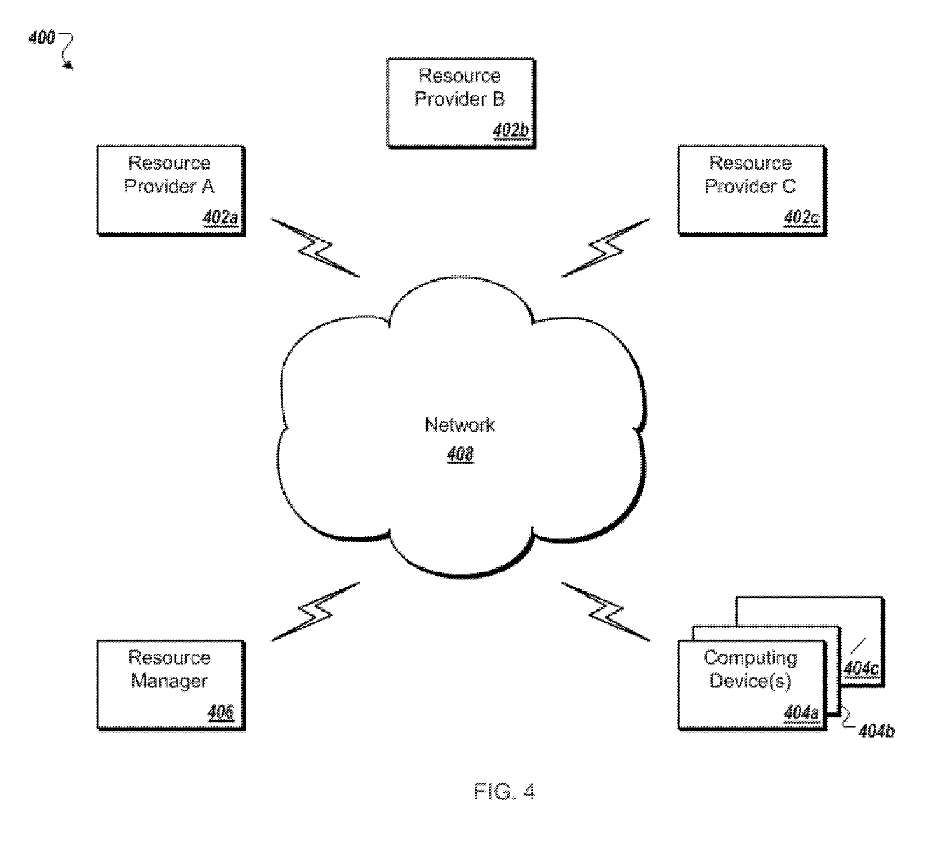

FIG. 4 shows an illustrative network environment 400 for use in the methods and systems described herein. In brief overview, referring now to FIG. 4, a block diagram of an exemplary cloud computing environment 400 is shown and described. The cloud computing environment 400 may include one or more resource providers 402a, 402b, 402c (collectively, 402). Each resource provider 402 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 402 may be connected to any other resource provider 402 in the cloud computing environment 400. In some implementations, the resource providers 402 may be connected over a computer network 408. Each resource provider 402 may be connected to one or more computing device 404a, 404b, 404c (collectively, 404), over the computer network 408.

The cloud computing environment 400 may include a resource manager 406. The resource manager 406 may be connected to the resource providers 402 and the computing devices 404 over the computer network 408. In some implementations, the resource manager 406 may facilitate the provision of computing resources by one or more resource providers 402 to one or more computing devices 404. The resource manager 406 may receive a request for a computing resource from a particular computing device 404. The resource manager 406 may identify one or more resource providers 402 capable of providing the computing resource requested by the computing device 404. The resource manager 406 may select a resource provider 402 to provide the computing resource. The resource manager 406 may facilitate a connection between the resource provider 402 and a particular computing device 404. In some implementations, the resource manager 406 may establish a connection between a particular resource provider 402 and a particular computing device 404. In some implementations, the resource manager 406 may redirect a particular computing device 404 to a particular resource provider 402 with the requested computing resource.

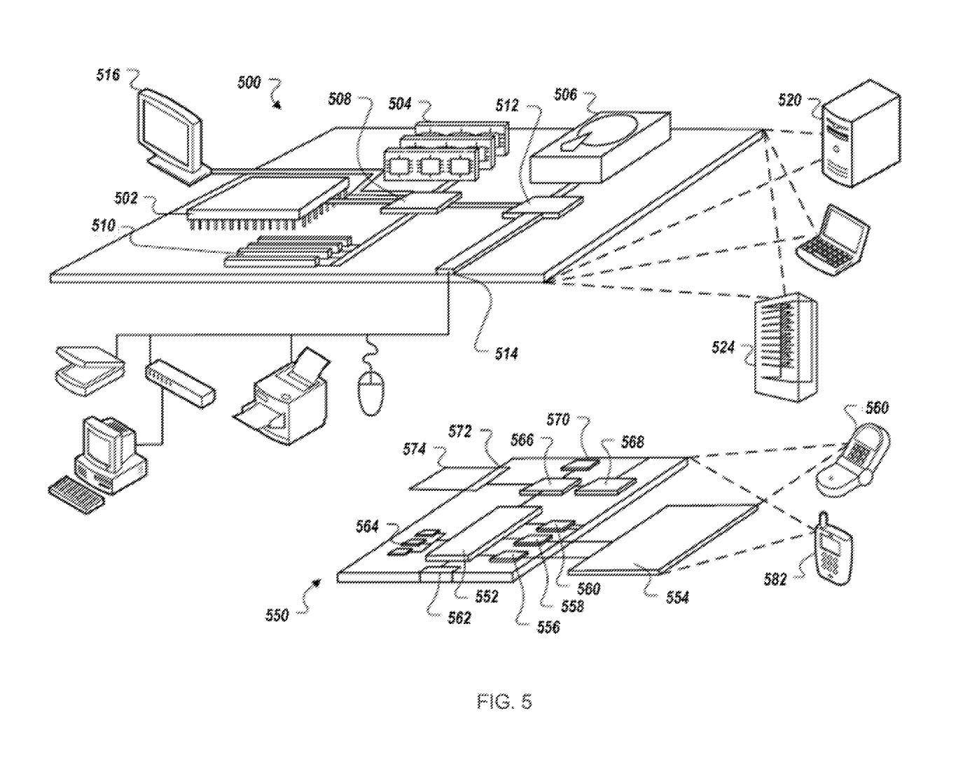

FIG. 5 shows an example of a computing device 500 and a mobile computing device 550 that can be used in the methods and systems described in this disclosure. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. In addition, it may be implemented in a personal computer such as a laptop computer 522. It may also be implemented as part of a rack server system 524. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provided as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth®, Wi-Fi™, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

1. A system for managing a displayless portable electronic device comprising:
at least one memory operable to store a plurality of media files, the plurality of media files being organized into a plurality of media groups;
at least one wireless communication antenna operable to communicate with one or more computing devices, each of the one or more computing devices comprising a display and executing a media service application; and
a processor communicatively coupled with the at least one memory and the at least one wireless communication antenna, the processor being operable to:
receive a first input selected from the group consisting of:
(i) a start-stop input providing access to a current media file among the plurality of media files;
(ii) a back input providing access a previous media file among the plurality of media files, relative to the current media file;
(iii) a forward input providing access to a next media file among the plurality of media files, relative to the current media file; and
(iv) a media group selector input for scrolling through the plurality of media files; and
execute the first command.

2. The system of claim 1, wherein
the start-stop input is a play-pause input, and
the media group selector input is a playlist selector input.

3. The system of claim 1, wherein the first input is received via a corresponding button selected from the group consisting of:
a start-stop button corresponding to the start-stop input,
a back button corresponding to the back input,
a forward button corresponding to the forward input, and
a media group selector button corresponding to the media group selector input.

4. The system of claim 2,
wherein the first input is the playlist selector input, and
wherein, responsive to the receiving of the first input, and to execute the first input, the processor is operable to:
for each media group among the plurality of media groups, output a dictation of a respective media group identifier.

5. The system of claim 4, wherein the processor is further operable to:
receive a second input within a given time measured from the output of the dictation of the respective media group identifier.

6. The system of claim 4, wherein the processor is further operable to:
receive a second input prior to the output of the dictation of a next respective media group identifier.

7. The system of claim 4, wherein the dictation of each respective media file group identifier corresponding to the plurality of media file groups is performed in a given order.

8. The system of claim 1, wherein the media files are audio files and the media groups are playlists.

9. The system of claim 1, wherein the at least one wireless communication antenna is selected from the group consisting of Bluetooth and Wi-Fi.

10. The system of claim 1, wherein the at least one memory is operable to store a media service application.

11. The system of claim 5, wherein the receiving of the second input, causes a media group corresponding to the last dictated media group identifier to be accessed.

12. The system of claim 1, wherein the processor is further operable to:
establish a virtual network computing (VNC) connection with a first computing device; and
receive, using the VNC connection, one or more media files or media groups selected at the computing device for offline access.

13. The system of claim 12, wherein the plurality of media files and/or the media service application stored and/or executing on the portable electronic device are managed via inputs received at the first computing device connected over the VNC connection.

14. The system of claim 13, wherein the inputs received at the first computing device connected over the VNC connection are received via peripheral devices connected to the first computing device.

15. A method for managing a displayless portable electronic device comprising:
storing, in at least one memory, a plurality of media files, the plurality of media files being organized into a plurality of media groups;
providing communications via at least one wireless communication antenna operable to communicate with one or more computing devices, each of the one or more computing devices comprising a display and executing a media service application;
receiving, by the processor, a first input selected from the group consisting of:
(i) a start-stop input providing access to a current media file among the plurality of media files;
(ii) a back input providing access a previous media file among the plurality of media files, relative to the current media file;
(iii) a forward input providing access to a next media file among the plurality of media files, relative to the current media file; and
(iv) a media group selector input for scrolling through the plurality of media files; and
executing, by the processor, the first command.

16. The method of claim 15, wherein
the start-stop input is a play-pause input, and
the media group selector input is a playlist selector input.

17. The method of claim 15, wherein the first input is received via a corresponding button selected from the group consisting of:
a start-stop button corresponding to the start-stop input,
a back button corresponding to the back input, p1 a forward button corresponding to the forward input, and
a media group selector button corresponding to the media group selector input.

18. The method of claim 16,
wherein the first input is the playlist selector input, and
wherein, responsive to the receiving of the first input, and to execute the first input, the method further comprises:
for each media group among the plurality of media groups, outputting a dictation of a respective media group identifier.

19. The method of claim 18, further comprising:
receiving, by the processor, a second input within a predetermined time measured from the output of the dictation of the respective media group identifier.

20. The method of claim 18, further comprising:
receiving, by the processor, a second input prior to the output of the dictation of a next respective media group identifier.

21. The method of claim 18, wherein the dictation of each respective media file group identifier corresponding to the plurality of media file groups is performed in a predetermined order.

22.-28. (canceled)
